(19) United States
(12) Patent Application Publication
(10) Pub. No.: US 2017/0104409 A1
(43) Pub. Date: Apr. 13, 2017

(54) ADAPTIVE BUS VOLTAGE AUTO-SELECTION SYSTEM

(71) Applicant: TEXAS INSTRUMENTS INCORPORATED, Dallas, TX (US)

(72) Inventor: ISAAC COHEN, DIX HILLS, NY (US)

(21) Appl. No.: 15/287,130

(22) Filed: Oct. 6, 2016

Related U.S. Application Data
(60) Provisional application No. 62/240,033, filed on Oct. 12, 2015.

(51) Int. Cl. H02M 3/07; H02M 7/06

(52) U.S. Cl. CPC H02M 3/073; H02M 7/06

(57) ABSTRACT

One example includes an adaptive bus voltage auto-selection system. The system includes an input bridge configured to rectify an AC input line voltage to generate a DC bus voltage. The system also includes a voltage monitor configured to monitor an amplitude of the AC input line voltage and to generate an activation signal based on the amplitude of the AC input line voltage relative to a predetermined reference voltage. The system further includes an anti-series transistor switch pair that is controlled via the activation signal to selectively couple and de-couple the input bridge to an output stage to provide the DC bus voltage at a first amplitude based on a first state of the activation signal and at a second amplitude based on a second state of the activation signal, respectively.

### RELATED APPLICATIONS

This application is claims priority from U.S. Provisional Patent Application Ser. No. 62/240033, filed 12Oct. 2015, which is incorporated herein in its entirety.

### TECHNICAL FIELD

This disclosure relates generally to electronic systems, and more specifically to an adaptive bus voltage auto-selection system.

### BACKGROUND

Power supply circuits can be implemented in a variety of computer and/or wireless devices to provide power to circuit components therein. One example of a power supply system is a DC-DC power converter that is configured to convert a DC voltage to another DC voltage of a different amplitude. DC input voltages can typically be generated from an AC input voltage, such as based on universal plug-in adapters. The efficiency of power converters can be limited by large input voltage operating ranges. Thus, some power supply systems, such as designed for worldwide use, include input voltage selection capability that can generate a DC bus voltage from the AC input line voltage. Such selection capability can be implemented to generate the DC bus voltage from different amplitudes of AC input line voltage.

### SUMMARY

One example includes an adaptive bus voltage auto-selection system. The system includes an input bridge configured to rectify an AC input line voltage to generate a DC bus voltage. The system also includes a voltage monitor configured to monitor an amplitude of the AC input line voltage and to generate an activation signal based on the amplitude of the AC input line voltage relative to a predetermined reference voltage. The system further includes an anti-series transistor switch pair that is controlled via the activation signal to selectively couple and de-couple the input bridge to an output stage to provide the DC bus voltage at a first amplitude based on a first state of the activation signal and at a second amplitude based on a second state of the activation signal, respectively.

Another example includes a method for generating a DC bus voltage based on an input AC line voltage. The method includes providing the AC input line voltage to an input bridge and comparing the amplitude of the AC input line voltage to a predetermined reference voltage. The method further includes generating an activation signal at one of a first state in response to the amplitude of the AC input line voltage being less than the predetermined reference voltage and a second state in response to the amplitude of the AC input line voltage being greater than or equal to the predetermined reference voltage to selectively couple and de-couple the input bridge to an output stage to provide the DC bus voltage at one of a first amplitude and a second amplitude, respectively.

Another example includes an adaptive bus voltage auto-selection system. The system includes an input bridge configured to rectify an AC input line voltage to generate a DC bus voltage. The system also includes a voltage monitor configured to monitor an amplitude of the AC input line voltage and to generate an activation signal based on the amplitude of the AC input line voltage relative to a predetermined reference voltage. The system also includes an anti-chatter circuit configured to activate an anti-chatter activation signal in response to the activation signal being generated in a first state for a comparison time duration. The system further includes an anti-series transistor switch pair that is controlled via the anti-chatter activation signal to selectively couple and de-couple the input bridge to an output stage to provide the DC bus voltage at a first amplitude based on the first state of the activation signal and at a second amplitude based on a second state of the activation signal, respectively.

### BRIEF DESCRIPTION OF THE DRAWINGS

FIG. 1 illustrates an example of an adaptive bus voltage auto-selection system.

FIG. 2 illustrates another example of an adaptive bus voltage auto-selection system.

FIG. 3 illustrates yet another example of an adaptive bus voltage auto-selection system.

FIG. 4 illustrates an example of a method for generating a DC bus voltage based on an input AC line voltage.

### DETAILED DESCRIPTION

This disclosure relates generally to electronic systems, and more specifically to an adaptive bus voltage auto-selection system. The adaptive bus voltage auto-selection system is configured to convert an AC input line voltage into a DC bus voltage based on an amplitude of the AC input line voltage. The adaptive bus voltage auto-selection system includes an input bridge that is configured to rectify the AC input line voltage and to provide the DC bus voltage based on the rectified AC input line voltage. The input bridge can be coupled to an output stage that includes a pair of capacitors that interconnect nodes associated with the DC bus voltage with a control node. In addition, the adaptive bus voltage auto-selection system includes a voltage monitor configured to compare the AC input line voltage (e.g., an absolute value of the AC input line voltage) with a predetermined reference voltage.

The voltage monitor can thus generate an activation signal that is configured to control an anti-series transistor switch pair that is configured to selectively couple and decouple the input bridge to and from the output stage, respectively, based on the comparison of the AC input line voltage with the predetermined reference voltage. Therefore, the AC input line voltage can be provided to generate the DC bus voltage at separate amplitudes based on the separate respective amplitudes of the AC input line voltage. Additionally, because the switch that interconnects the input bridge and the output stage is implemented as an anti-series transistor pair, the switching of the adaptive bus voltage auto-selection system between modes (e.g., doubler mode and bridge mode) can be implemented in a much more rapid and power efficient manner.

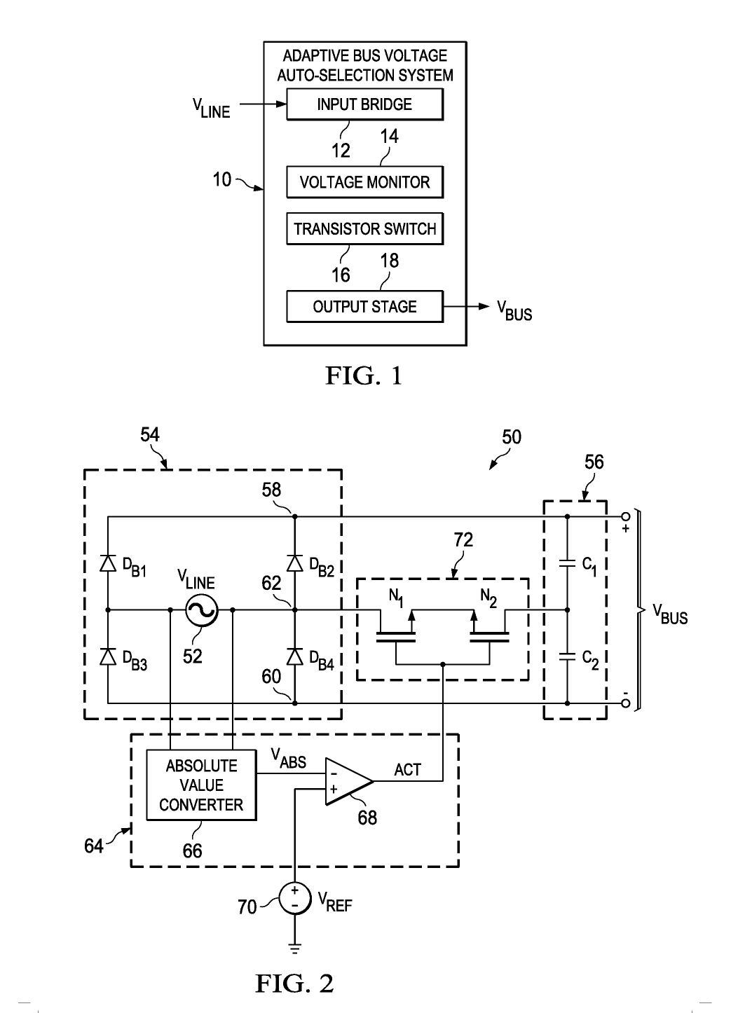

FIG. 1 illustrates an example of an adaptive bus voltage auto-selection system 10. The adaptive bus voltage auto-selection system 10 can be implemented in a variety of circuit applications to generate a DC bus voltage V_{BUS} based on an AC input line voltage V_{LINE}. As an example, the AC input line voltage V_{LINE} can be provided from a local power grid associated with public utility, and the DC bus voltage V_{BUS} can be provided as a DC input voltage for a circuit system (e.g., a DC-DC power supply system).

The adaptive bus voltage auto-selection system 10 includes an input bridge 12 and an output stage 14. The input bridge 12 can be configured, for example, as a diode-based input rectifier, and the output stage 14 can be configured as a capacitor pair that interconnects nodes on which the DC bus voltage V_{BUS} is provided. The input bridge 12 can thus be configured to receive the AC input line voltage V_{LINE} and to rectify the AC input line voltage V_{LINE}. As an example, the input bridge 12 can be coupled to the output stage 14, such that the rectified AC input line voltage V_{LINE} is provided to the output stage 14 to be filtered by the output stage 14, and thus provided as the DC bus voltage V_{BUS}. As described in greater detail herein, the adaptive bus voltage auto-selection system 10 can operate in one of two modes. A first mode can correspond to a voltage doubler mode associated with a lesser amplitude of the AC input line voltage V_{LINE}, and thus a lesser amplitude of the DC bus voltage V_{BUS}. A second mode can correspond to a bridge mode associated with a greater amplitude of the AC input line voltage V_{LINE}, and thus a greater amplitude of the DC bus voltage V_{BUS}.

The adaptive bus voltage auto-selection system 10 also includes a voltage monitor 16 that is configured to monitor the amplitude of the AC input line voltage V_{LINE}. The voltage monitor 16 can compare the amplitude of the AC input line voltage V_{LINE} with a predetermined reference voltage and generate an activation signal having a logic-state that corresponds to the comparison. As an example, the voltage monitor 16 can include an absolute value converter that is configured to generate an absolute value voltage corresponding to an absolute value amplitude of the AC input line voltage V_{LINE}. Thus, the voltage monitor 16 can compare the amplitude of the absolute value voltage with the predetermined reference voltage to generate the activation signal. Thus, the activation signal can correspond to the state of the adaptive bus voltage auto-selection system.

The adaptive bus voltage auto-selection system 10 further includes an anti-series transistor pair 18. As described herein, the term “anti-series transistor pair” refers to a pair of transistors that are arranged in series but opposite orientation with respect to each other, and which are commonly controlled by a single signal. As an example, the anti-series transistor pair 18 can be arranged as a pair of N-channel field-effect transistors (FETs) (e.g., metal-oxide semiconductor (MOS)FETs) having a common source. However, the anti-series transistor pair 18 is not limited to N-channel FETs, but can instead be configured as any of a variety of other transistor pairs of various orientations, such as drain-connected N-FETs, NPN or PNP bipolar junction transistors (BJTs), P-channel FETs, J-FETs, LDMOSFETs, or other types of transistors.

The anti-series transistor pair 18 can be collectively controlled via the activation signal that is generated via the voltage monitor 16. The anti-series transistor pair 18 interconnects the input bridge 12 and the output stage 14. For example, the anti-series transistor pair 18 can interconnect the input bridge 12 and a control node that interconnects the two capacitors associated with the output stage 14. As a result, the anti-series transistor pair 18 can activate to couple the input bridge 12, and thus one leg of the AC input line voltage V_{LINE}, to the control node to facilitate operation of the adaptive bus voltage auto-selection system 10 in the doubler mode, and can deactivate the decouple the input bridge 12, and thus the one leg of the AC input line voltage V_{LINE}, from the control node to facilitate operation of the adaptive bus voltage auto-selection system 10 in the bridge mode.

Therefore, the adaptive bus voltage auto-selection system 10 implements the anti-series transistor pair 18 to switch from the bridge mode to the doubler mode in a very rapid and power efficient manner. Thus, the anti-series transistor pair 18 provides a much more rapid switching solution than switching solutions provided by other typical adaptive bus voltage auto-selection systems, such as that implement a relay or a triac. As a result, the very rapid switching of the anti-series transistor pair 18 can substantially mitigate overvoltage conditions that result from a delay in switching in response to step-voltage changes. Furthermore, the anti-series transistor pair 18 can have a much lower voltage across it when activated than other switching solutions, and is therefore more power efficient. Therefore, the anti-series transistor pair 18 can provide a more efficient and effective switching solution.

FIG. 2 illustrates another example of an adaptive bus voltage auto-selection system 50. The adaptive bus voltage auto-selection system 50 can be implemented in a variety of circuit applications to generate a DC bus voltage V_{BUS} based on an AC input line voltage V_{LINE} that is demonstrated as being generated via an AC power source 52, which can correspond to a local power grid associated with public utility.

The adaptive bus voltage auto-selection system 50 includes an input bridge 54 and an output stage 56. The input bridge 54 is demonstrated in the example of FIG. 2 as a diode-based input rectifier that includes diodes D_{B1}, D_{B2}, D_{B3}, and D_{B4}, with the AC input line voltage WINE being provided at the anode of the diode D_{B1} and the cathode of the diode D_{B3} and at the anode of the diode D_{B2} and the cathode of the diode D_{B4}. The input bridge 54 can thus be configured to receive the AC input line voltage V_{LINE} and to rectify the AC input line voltage V_{LINE}. The output stage 56 is demonstrated in the example of FIG. 2 as a capacitor pair C₁ and C₂ that interconnects a first node 58 and a second node 60 on which the DC bus voltage V_{BUS} is provided. Particularly, the first capacitor C₁ interconnects the first node 58 and a control node 62, and the second capacitor C₂ interconnects the second node 60 and the control node 62. The first node 58 is also coupled to the cathodes of the diodes D_{B1} and D_{B2} , and the second node 60 is also coupled to the anodes of the diodes D_{B3} and D_{B4}. Therefore, the rectified AC input line voltage V_{LINE} is provided to the output stage 56 to be filtered by the output stage 56, and thus provided as the DC bus voltage V_{BUS}. As described herein, the adaptive bus voltage auto-selection system 50 can operate in either a voltage doubler mode or a bridge mode.

The adaptive bus voltage auto-selection system 50 also includes a voltage monitor 64 that is configured to monitor the amplitude of the AC input line voltage V_{LINE}. In the example of FIG. 2, the voltage monitor 64 includes an absolute value converter 66 that is configured to generate an absolute value voltage V_{ABS} corresponding to an absolute value amplitude of the AC input line voltage V_{LINE}. The voltage monitor 64 also includes a comparator 68 that is configured to receive the absolute value voltage V_{ABS} at an inverting input and a reference voltage V_{REF} at a non-inverting input. The reference voltage V_{REF} is demonstrated as being generated via a voltage supply 70, such as provided externally (e.g., provided to a pin on the IC chip in which the adaptive bus voltage auto-selection system 50 is arranged). The comparator 68 thus compares the absolute value voltage V_{ABS} with the reference voltage V_{REF} to generate an activation signal ACT having a logic-state that is based on the amplitude of the absolute value voltage V_{ABS} relative to the reference voltage V_{REF}.

The adaptive bus voltage auto-selection system 50 further includes an anti-series transistor pair 72. In the example of FIG. 2, the anti-series transistor pair 72 is demonstrated as a pair of N-FETs N₁ and N₂ having a common source connection. The anti-series transistor pair 72 interconnects the input bridge 52, at the anode of the diode D_{B2} and the cathode of the diode D_{B4}, and the control node 62 of the output stage 56. The gate of each of the N-FETs N₁ and N₂ of the anti-series transistor pair 72 is controlled by the activation signal ACT, such that the activation signal ACT is provided to activate and deactivate the anti-series transistor pair 72.

In the example of FIG. 2, if the absolute value voltage V_{ABS} is greater than or equal to the reference voltage V_{REF}, corresponding for example to a 230 VAC amplitude of the AC input line voltage V_{LINE}, the activation signal ACT is provided at a logic-low state. Thus, the anti-series transistor pair 72 is deactivated to provide an open circuit between the input bridge 52 and the control node 62. Accordingly, the adaptive bus voltage auto-selection system 50 operates in the bridge mode to provide the DC bus voltage V_{BUS} at a first amplitude. If the absolute value voltage V_{ABS} is less than the reference voltage V_{REF}, corresponding for example to a 110 VAC amplitude of the AC input line voltage V_{LINE}, the activation signal ACT is provided at a logic-high state. Thus, the anti-series transistor pair 72 is rapidly activated to couple the input bridge 52 to the control node 62. Accordingly, the adaptive bus voltage auto-selection system 50 operates in the doubler mode to provide the DC bus voltage V_{BUS} at a second amplitude.

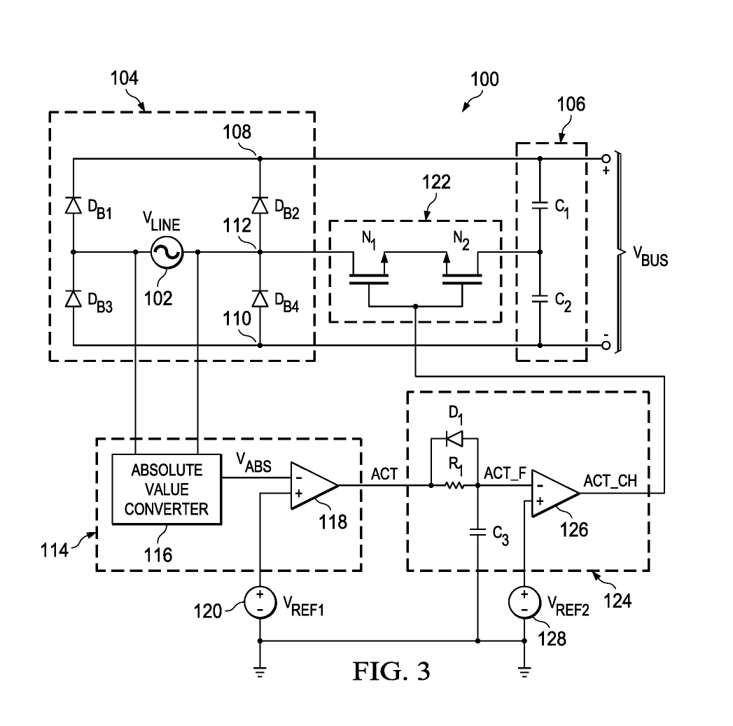

FIG. 3 illustrates yet another example of an adaptive bus voltage auto-selection system 100. The adaptive bus voltage auto-selection system 100 can be implemented in a variety of circuit applications to generate a DC bus voltage V_{BUS} based on an AC input line voltage V_{LINE} that is demonstrated as being generated via an AC power source 102, which can correspond to a local power grid associated with public utility. The adaptive bus voltage auto-selection system 100 is demonstrated in the example of FIG. 3 as being substantially similar to the adaptive bus voltage auto-selection system 50 in the example of FIG. 2. However, as described in greater detail herein, the adaptive bus voltage auto-selection system 100 can be configured to substantially mitigate chatter associated with the change of state of the activation signal ACT.

The adaptive bus voltage auto-selection system 100 includes an input bridge 104 and an output stage 106. The input bridge 104 is demonstrated in the example of FIG. 3 as a diode-based input rectifier that includes diodes D_{B1}, D_{B2}, D_{B3}, and D_{B4}, with the AC input line voltage V_{LINE} being provided at the anode of the diode D_{B1} and the cathode of the diode D_{B3} and at the anode of the diode D_{B2} and the cathode of the diode D_{B4}. The input bridge 104 can thus be configured to receive the AC input line voltage V_{LINE} and to rectify the AC input line voltage V_{LINE}. The output stage 106 is demonstrated in the example of FIG. 3 as a capacitor pair C₁ and C₂ that interconnects a first node 108 and a second node 110 on which the DC bus voltage V_{Bus} is provided. Particularly, the first capacitor C₁ interconnects the first node 108 and a control node 112, and the second capacitor C₂ interconnects the second node 110 and the control node 112. The first node 108 is also coupled to the cathodes of the diodes D_{B1} and D_{B2} , and the second node 110 is also coupled to the anodes of the diodes D_{B3} and D_{B4} . Therefore, the rectified AC input line voltage V_{LINE} is provided to the output stage 106 to be filtered by the output stage 106, and thus provided as the DC bus voltage V_{BUS}. As described herein, the adaptive bus voltage auto-selection system 100 can operate in either a voltage doubler mode or a bridge mode.

The adaptive bus voltage auto-selection system 100 also includes a voltage monitor 114 that is configured to monitor the amplitude of the AC input line voltage V_{LINE}. In the example of FIG. 3, the voltage monitor 114 includes an absolute value converter 116 that is configured to generate an absolute value voltage V_{ABS} corresponding to an absolute value amplitude of the AC input line voltage V_{LINE}. The voltage monitor 114 also includes a comparator 118 that is configured to receive the absolute value voltage V_{ABS}at an inverting input and a first reference voltage V_{REF1} at a non-inverting input. The first reference voltage V_{REF1} is demonstrated as being generated via a voltage supply 120, such as provided externally (e.g., provided to a pin on the IC chip in which the adaptive bus voltage auto-selection system 100 is arranged). The comparator 118 thus compares the absolute value voltage V_{ABS} with the first reference voltage V_{REF1} to generate an activation signal ACT having a logic-state that is based on the amplitude of the absolute value voltage V_{ABS} relative to the first reference voltage V_{REF1}. Further, as described in greater detail herein, the adaptive bus voltage auto-selection system 100 also includes an anti-series transistor pair 122 that operates similar to as described previously based on the activation signal ACT.

Because the AC input line voltage V_{LINE} can decrease less than the first reference voltage V_{REF1} even at a higher amplitude (e.g., 230 VAC), the transition from the higher amplitude of the AC input line voltage V_{LINE} to the lower amplitude of the AC input line voltage V_{LINE} can result in chatter associated with the activation signal ACT, such that the activation signal ACT can change state twice in a given half-period of the AC input line voltage V_{LINE}. Such chatter can provide conduction pulses associated with the anti-series transistor pair 122 that can, in turn, increase root-mean square (RMS) currents in the adaptive bus voltage auto-selection system 100, and thus further power dissipation of the adaptive bus voltage auto-selection system 100.

To substantially mitigate chatter, the adaptive bus voltage auto-selection system 100 includes an anti-chatter circuit 124 that receives the activation signal ACT and provides an anti-chatter activation signal ACT_CH. The anti-chatter activation signal ACT_CH thus changes state in response to a change of state of the activation signal ACT that is maintained for more than one-half the period of the AC input line voltage V_{LINE}. The anti-chatter circuit 124 includes an RC filter that is arranged with a resistor R₁ and a capacitor C₃ that provides a filtered activation signal ACT_F, and further includes a feedback diode D₁ that provides feedback of the filtered activation signal ACT_F to the activation signal ACT. The filtered activation signal ACT_F is thus provided to an inverting input of a comparator 126 that is configured to compare the filtered activation signal ACT_F with a second reference voltage V_{REF2}. The second reference voltage V_{REF2} is demonstrated as being generated via a voltage supply 128, such as provided externally (e.g., provided to a pin on the IC chip in which the adaptive bus voltage auto-selection system 100 is arranged). The comparator 126 can thus generate the anti-chatter activation signal ACT_CH based on the comparison of the filtered activation signal ACT_F with the second reference voltage V_{REF2}. Based on the RC filter arrangement of the resistor R₁ and the capacitor C₃, and the feedback diode D₁, the filtered activation signal ACT_F is only de-asserted after the activation signal ACT is de-asserted for more than half of a period of the AC input line voltage V_{LINE}, such that the comparator 126 likewise generates the anti-chatter activation signal ACT_CH after more than half of a period of the AC input line voltage V_{LINE}.

Similar to as demonstrated in the example of FIG. 2, the anti-series transistor pair 122 is demonstrated as a pair of N-FETs N₁ and N₂ having a common source connection in the example of FIG. 3. The anti-series transistor pair 122 interconnects the input bridge 102, at the anode of the diode D_{B2} and the cathode of the diode D_{B4}, and the control node 112 of the output stage 106. The gate of each of the N-FETs N₁ and N₂ of the anti-series transistor pair 122 is controlled by the anti-chatter activation signal ACT_CH, such that the anti-chatter activation signal ACT_CH is provided to activate and deactivate the anti-series transistor pair 122.

Accordingly, if the absolute value voltage V_{ABS}is greater than or equal to the first reference voltage V_{REF}, corresponding for example to a 230 VAC amplitude of the AC input line voltage V_{LINE}, the activation signal ACT is provided at a logic-low state. In response, the filtered activation signal ACT_F can be driven to the logic-low state, and is compared with the second reference voltage V_{REF2}. Based on the comparison of the filtered activation signal ACT_F with the second reference voltage V_{REF2}, the anti-chatter activation signal ACT_CH is provided at a logic-low state. Therefore, the anti-series transistor pair 122 is deactivated to provide an open circuit between the input bridge 102 and the control node 112, such that the adaptive bus voltage auto-selection system 100 operates in the bridge mode to provide the DC bus voltage V_{BUS} at a first amplitude.

Similarly, if the absolute value voltage V_{ABS} is less than the first reference voltage V_{REF1}, corresponding for example to a 110 VAC amplitude of the AC input line voltage V_{LINE}, the activation signal ACT is provided at a logic-high state. In response, the filtered activation signal ACT_F can be driven to the logic-high state, and is compared with the second reference voltage V_{REF2}. Based on the comparison of the filtered activation signal ACT_F with the second reference voltage V_{REF2}, the anti-chatter activation signal ACT_CH is provided at a logic-high state. Therefore, the anti-series transistor pair 122 is rapidly activated to couple the input bridge 102 to the control node 112, such that the adaptive bus voltage auto-selection system 100 operates in the doubler mode to provide the DC bus voltage V_{BUS} at a second amplitude.

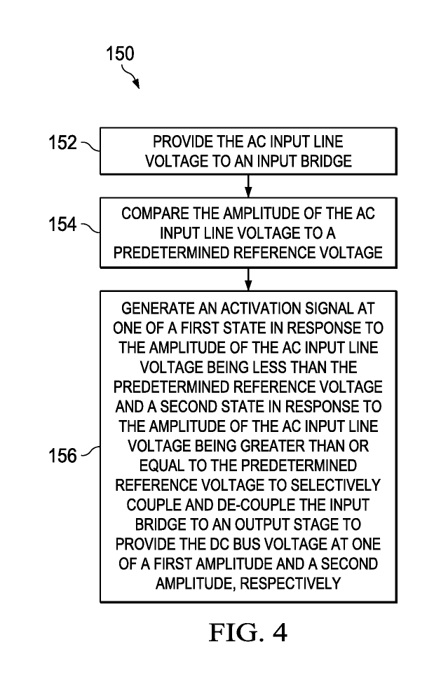

In view of the foregoing structural and functional features described above, a method in accordance with various aspects of the present disclosure will be better appreciated with reference to FIG. 4. While, for purposes of simplicity of explanation, the method of FIG. 4 is shown and described as executing serially, it is to be understood and appreciated that the present disclosure is not limited by the illustrated order, as some aspects could, in accordance with the present disclosure, occur in different orders and/or concurrently with other aspects from that shown and described herein. Moreover, not all illustrated features may be required to implement a method in accordance with an aspect of the present disclosure.

FIG. 4 illustrates a method 150 for generating a DC bus voltage (e.g., the DC bus voltage V_{BUS}) based on an input AC line voltage (e.g., the AC line voltage V_{LINE}). At 152, the AC input line voltage is provided to an input bridge (e.g., the input bridge 12). At 154, the amplitude of the AC input line voltage is compared to a predetermined reference voltage (e.g., the reference voltage V_{REF}). At 156, an activation signal (e.g., the activation signal ACT) is provided at one of a first state in response to the amplitude of the AC input line voltage being less than the predetermined reference voltage and a second state in response to the amplitude of the AC input line voltage being greater than or equal to the predetermined reference voltage to selectively couple and de-couple the input bridge to an output stage (e.g., the output stage 14) to provide the DC bus voltage at one of a first amplitude and a second amplitude, respectively.

What have been described above are examples of the disclosure. It is, of course, not possible to describe every conceivable combination of components or method for purposes of describing the disclosure, but one of ordinary skill in the art will recognize that many further combinations and permutations of the disclosure are possible. Accordingly, the disclosure is intended to embrace all such alterations, modifications, and variations that fall within the scope of this application, including the appended claims.

What is claimed is:

1. An adaptive bus voltage auto-selection system comprising:
an input bridge configured to rectify an AC input line voltage to generate a DC bus voltage;
a voltage monitor configured to monitor an amplitude of the AC input line voltage and to generate an activation signal based on the amplitude of the AC input line voltage relative to a predetermined reference voltage; and
an anti-series transistor switch pair that is controlled via the activation signal to selectively couple and de-couple the input bridge to an output stage to provide the DC bus voltage at a first amplitude based on a first state of the activation signal and at a second amplitude based on a second state of the activation signal, respectively.

2. The system of claim 1, wherein the output stage comprises:
a first capacitor interconnecting a control node and a first bus node; and
a second capacitor interconnecting the control node and a second bus node, the DC bus voltage being provided on the first bus node relative to the second bus node.

3. The system of claim 2, wherein the anti-series transistor switch pair is configured to couple the input bridge to the control node in response to being activated via the activation signal, and to decouple the input bridge from the control node in response to being deactivated via the activation signal.

4. The system of claim 1, wherein the voltage monitor comprises:
an absolute value converter configured to generate an absolute value voltage having an amplitude that corresponds to an absolute value of the AC input line voltage; and
a comparator configured to compare the absolute value voltage with the predetermined reference voltage and to generate the activation signal in response to the comparison.

5. The system of claim 4, wherein the comparator is configured to provide the activation signal at a logic-high state to activate the anti-series transistor switch pair in response to the absolute value voltage being less than the predetermined reference voltage, and to provide the activation signal at a logic-low state to deactivate the anti-series transistor switch pair in response to the absolute value voltage being greater than or equal to the predetermined reference voltage.

6. The system of claim 1, further comprising an anti-chatter circuit configured to implement a comparison time duration for the voltage monitor to substantially mitigate chatter associated with activation of the anti-series transistor switch pair.

7. The system of claim 6, wherein the anti-chatter circuit is configured to generate an anti-chatter activation signal that is configured to control the anti-series transistor switch pair in response to the activation signal, the anti-chatter activation signal being asserted or de-asserted based on the amplitude of the AC input line voltage having an amplitude that is less than or greater than or equal to the predetermined reference voltage, respectively, for more than half of a period of the AC input line voltage.

8. The system of claim 7, wherein the anti-chatter circuit is configured to assert the anti-chatter activation signal to activate the anti-series transistor switch pair in response to the activation signal being less than the predetermined reference voltage for more than half of the period of the AC input line voltage.

9. The system of claim 6, wherein the anti-chatter circuit comprises:
an RC filter configured to filter the activation signal to generate a filtered activation signal;
a feedback diode configured to provide feedback of the filtered activation signal to the activation signal; and
a comparator configured to compare the filtered activation signal with a second predetermined reference voltage and to generate the anti-chatter activation signal in response to the comparison.

10. An integrated circuit (IC) chip system comprising at least a portion of the adaptive voltage doubler system of claim 1.

11. A method for generating a DC bus voltage based on an input AC line voltage, the method comprising:
providing the AC input line voltage to an input bridge;
comparing the amplitude of the AC input line voltage to a predetermined reference voltage; and
generating an activation signal at one of a first state in response to the amplitude of the AC input line voltage being less than the predetermined reference voltage and a second state in response to the amplitude of the AC input line voltage being greater than or equal to the predetermined reference voltage to selectively couple and de-couple the input bridge to an output stage to provide the DC bus voltage at one of a first amplitude and a second amplitude, respectively.

12. The method of claim 11, wherein comparing the amplitude of the AC input line voltage comprises:
generating an absolute value voltage having an amplitude that corresponds to an absolute value of the AC input line voltage; and
comparing the absolute value voltage with the predetermined reference voltage, wherein generating the activation signal comprises generating the activation signal at one of the first state in response to the amplitude of the absolute value voltage being less than the predetermined reference voltage and the second state in response to the amplitude of the absolute value voltage being greater than or equal to the predetermined reference voltage.

13. The method of claim 11, wherein the output stage comprises:
a first capacitor interconnecting a control node and a first bus node; and
a second capacitor interconnecting the control node and a second bus node, the DC bus voltage being provided on the first bus node relative to the second bus node, wherein generating the activation signal comprises generating the activation signal in the first state to couple the input bridge to the control node and in the second state to decouple the input bridge from the control node in response to being deactivated via the activation signal.

14. The method of claim 11, wherein comparing the amplitude of the AC input line voltage comprises comparing the amplitude of the AC input line voltage to the predetermined reference voltage for a predetermined time duration via an anti-chatter circuit to substantially mitigate chatter associated with activation of the anti-series transistor switch pair.

15. The method of claim 14, wherein the anti-chatter circuit comprises:
an RC filter configured to filter the activation signal to generate a filtered activation signal;
a feedback diode configured to provide feedback of the filtered activation signal to the activation signal; and
a comparator configured to compare the filtered activation signal with a second predetermined reference voltage and to generate the anti-chatter activation signal in response to the comparison.

16. An adaptive bus voltage auto-selection system comprising:
an input bridge configured to rectify an AC input line voltage to generate a DC bus voltage;
a voltage monitor configured to monitor an amplitude of the AC input line voltage and to generate an activation signal based on the amplitude of the AC input line voltage relative to a predetermined reference voltage;
an anti-chatter circuit configured to activate an anti-chatter activation signal in response to the activation signal being generated in a first state for a comparison time duration; and
an anti-series transistor switch pair that is controlled via the anti-chatter activation signal to selectively couple and de-couple the input bridge to an output stage to provide the DC bus voltage at a first amplitude based on the first state of the activation signal and at a second amplitude based on a second state of the activation signal, respectively.

17. The system of claim 16, wherein the voltage monitor comprises:
an absolute value converter configured to generate an absolute value voltage having an amplitude that corresponds to an absolute value of the AC input line voltage; and
a comparator configured to compare the absolute value voltage with the predetermined reference voltage and to generate the activation signal in response to the comparison.

18. The system of claim 17, wherein the comparator is configured to provide the activation signal at a logic-high state to activate the anti-series transistor switch pair in response to the absolute value voltage being less than the predetermined reference voltage, and to provide the activation signal at a logic-low state to deactivate the anti-series transistor switch pair in response to the absolute value voltage being greater than or equal to the predetermined reference voltage.

19. The system of claim 16, wherein the anti-chatter circuit is configured to assert the anti-chatter activation signal to activate the anti-series transistor switch pair in response to the activation signal being less than the predetermined reference voltage for more than half of the period of the AC input line voltage.

20. The system of claim 16, wherein the anti-chatter circuit comprises:
an RC filter configured to filter the activation signal to generate a filtered activation signal;
a feedback diode configured to provide feedback of the filtered activation signal to the activation signal; and
a comparator configured to compare the filtered activation signal with a second predetermined reference voltage and to generate the anti-chatter activation signal in response to the comparison.
